(19) United States
(12) Patent Application Publication
(10) Pub. No.: US 2014/0005907 A1
(43) Pub. Date: Jan. 2, 2014

(54) VISION-BASED ADAPTIVE CRUISE CONTROL SYSTEM

(71) Applicant: MAGNA ELECTRONICS INC., Auburn Hills, MI (US)

(72) Inventor: Devendra Bajpai, Bloomfield Hills, MI (US)

(21) Appl. No.: 13/927,680

(22) Filed: Jun. 26, 2013

Related U.S. Application Data
(60) Provisional application No. 61/666,146, filed on Jun. 29, 2012.

(51) Int. Cl. B60K 31/00

(52) U.S. Cl. CPC B60K 31/0008
USPC 701/96

(57) ABSTRACT

An adaptive cruise control system for a vehicle includes a camera having a field of view forward of a vehicle and operable to capture image data. A traffic situation classifier, responsive to captured image data, determines a traffic condition ahead of the vehicle. A control is operable to process captured image data and, at least in part responsive to the traffic situation classifier, generate an output to accelerate or decelerate the vehicle to establish a desired or appropriate velocity of the vehicle based on the determined traffic condition and image data processing.

### CROSS REFERENCE TO RELATED APPLICATION

The present application claims the filing benefit of U.S. provisional application, Ser. No. 61/666,146, filed Jun. 29, 2012, which is hereby incorporated herein by reference in its entirety.

### FIELD OF THE INVENTION

The present invention relates to imaging systems or vision systems for vehicles and, more particularly, to a vision-based adaptive cruise control system for a vehicle.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides an adaptive cruise control system for a vehicle that utilizes one or more cameras to capture images exterior of the vehicle, and controls the brake system and/or throttle system of the vehicle to control the speed of the vehicle when a user actuates a cruise control system of the vehicle.

According to an aspect of the present invention, an adaptive cruise control system for a vehicle includes a camera (such as a forward facing camera at a vehicle that has a forward field of view), a traffic situation classifier and a control. The camera captures image data and the traffic situation classifier, responsive at least in part to the captured image data, determines a traffic and/or road condition ahead of the subject vehicle. The control, responsive at least in part to the traffic situation classifier, is operable to process captured image data and to accelerate or decelerate the vehicle to establish a desired or appropriate velocity of the vehicle based on the current traffic and/or road conditions. The adaptive cruise control system thus provides enhanced control of the vehicle speed responsive to the current traffic and/or road conditions and provides such enhanced control responsive to a forward facing camera or image sensor.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system and imaging sensors or cameras that provide exterior fields of view in accordance with the present invention;

FIG. 2 is a schematic of a known prior art cruise control system; and

FIG. 3 is a schematic of a vision only adaptive cruise control system in accordance with the present invention.

### DESCRIPTION OF THE PREFERRED EMBODIMENTS

A driver assist system and/or vision system and/or object detection system and/or adaptive cruise control system and/or alert system may operate to capture images exterior of the vehicle and process the captured image data to detect objects at or near the vehicle and in the predicted path of the vehicle, such as to assist a driver of the vehicle in maneuvering the vehicle in a rearward direction. The object detection may utilize detection and analysis of moving vectors representative of objects detected in the field of view of the vehicle camera, in order to determine which detected objects are objects of interest to the driver of the vehicle, such as when the driver of the vehicle undertakes a reversing maneuver.

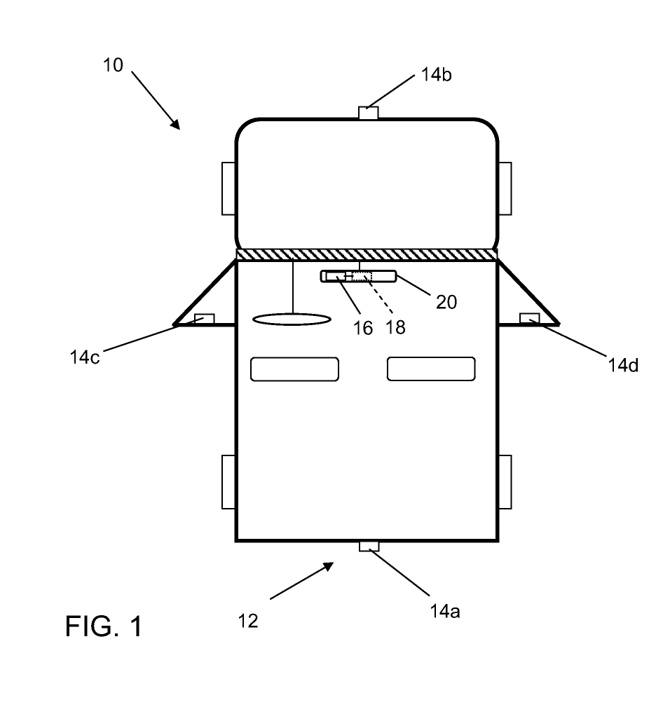

Referring now to the drawings and the illustrative embodiments depicted therein, a vehicle 10 includes an imaging system or vision system 12 that includes one or more imaging sensors or cameras (such as a rearward facing imaging sensor or camera 14a and/or a forwardly facing camera 14b at the front (or at the windshield) of the vehicle, and/or a sidewardly/rearwardly facing camera 14c, 14b at the sides of the vehicle), which capture images exterior of the vehicle, with the cameras having a lens for focusing images at or onto an imaging array or imaging plane of the camera (FIG. 1). The vision system 12 includes a control or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The vision system processes image data to detect objects, such as objects forward (and/or to the rear) of the subject or equipped vehicle, such as approaching or following vehicles or vehicles at a side lane adjacent to the subject or equipped vehicle or the like.

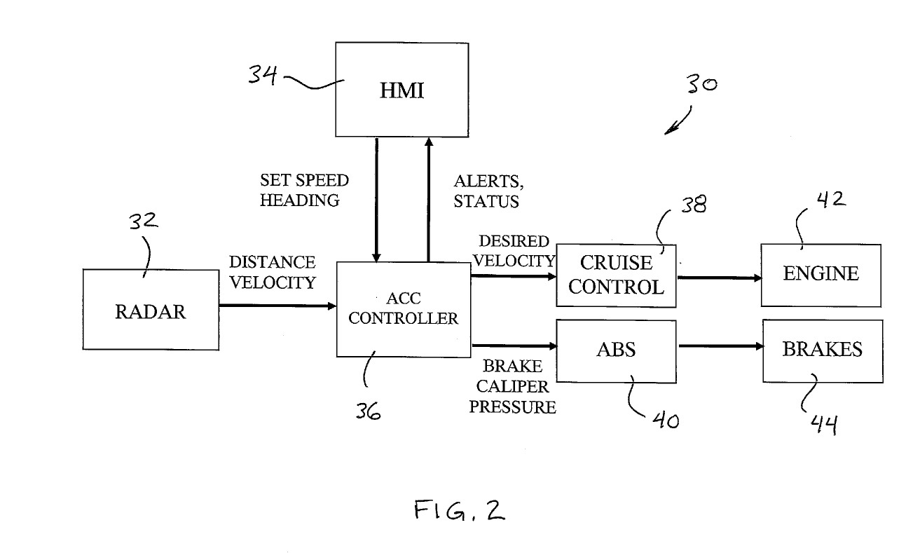

As shown in FIG. 2, a typical or known adaptive cruise control system 30 includes a radar sensing device 32 and a human machine interface 34, which provide inputs to a controller 36. The controller 36 generates outputs to an accelerator control or cruise control 38 and to a brake system 40 (such as an anti-lock braking system or the like) to control the engine 42 and brakes 44 of the vehicle.

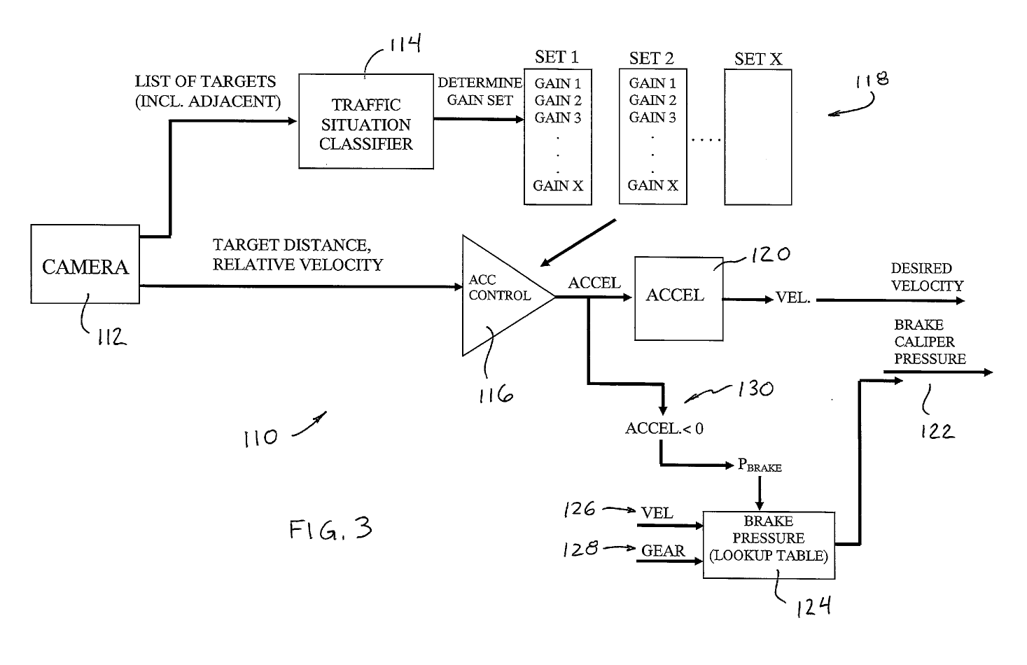

The present invention provides a vision only adaptive cruise control system that utilizes a forward facing camera or image sensor and controls the speed of the vehicle responsive to Referring now to FIG. 3, an adaptive cruise control system 110 includes a camera 112 (such as forward facing camera 14b of FIG. 1 or the like), a traffic situation classifier 114 (which includes or is associated with an image processor that is operable to process image data captured by the camera 112) and a control or controller 116.

In such an adaptive cruise control (ACC) system, the camera sensor 112 not only provides distance and relative velocity to the ACC controller 116, but also provides additional information to the traffic situation classifier 114. The camera sensor 112 may comprise or include or be associated with an image processor that processes image data captured by the camera (whereby the processor provides the appropriate output to the traffic situation classifier and to the controller) or the traffic situation classifier and the controller may include image processing capabilities to process image data captured by the camera.

The additional information provided by the camera 112 to the traffic situation classifier 114 may comprise information about a target vehicle that the subject vehicle is following, such as information pertaining to a target vehicle flasher or turn signal, a target vehicle brake light, a target vehicle position in the lane, a target vehicle lateral velocity and/or the like. Optionally, the additional information provided to the classifier 114 may include information about adjacent vehicles that the subject vehicle is not following but that may enter the lane occupied by the subject vehicle, such as information for each of the vehicles, such as an adjacent vehicle flasher or turn signal, an adjacent vehicle brake light, an adjacent vehicle position in the lane, an adjacent vehicle lateral velocity and/or the like. The additional information provided to the classifier 114 may include road Information pertaining to the road on which the subject vehicle is traveling. For example, the additional information may include information pertaining to or indicative of a road curvature, detection of a “curve ahead” traffic sign, a presence of an entry ramp (such as a highway entry ramp), a presence of an exit ramp (such as a highway exit ramp), a speed limit (as detected by the camera alone or fused with navigation), a presence of a construction area (such as detection of a construction area sign or flag), and/or the like.

The traffic situation classifier 114 selects or determines an appropriate one of a plurality of possible gain sets 118 for the ACC controller 116 based on the traffic situation derived from the additional information. The gain set 118 determines the acceleration and deceleration behavior of the vehicle. For example, the traffic situation classifier 114 may, based on adjacent vehicle flasher and adjacent vehicle lateral velocity, determine a scenario of an “anticipated cut in” and the controller 116 may select a reduced acceleration or even deceleration where, without the traffic situation classifier, the system would otherwise have accelerated.

The output of the ACC controller 116 comprises an acceleration signal (positive or negative). The system outputs of the ACC set speed are derived by integration of the internal acceleration signal. If the controller 116 determines that the vehicle should be accelerated, a positive acceleration signal is generated for the acceleration system 120 of the vehicle, whereby the vehicle is accelerated to the appropriate or determined or desired velocity. If the controller 116 determines that the vehicle should be decelerated, a negative acceleration signal is generated for the brake system of the vehicle, whereby the vehicle is decelerated the appropriate or determined or desired amount. The brake system output of brake caliper pressure 122 may be derived by a look-up table 124, which uses vehicle speed 126, selected gear 128 and the desired deceleration 130 to derive the appropriate brake caliper pressure to achieve the desired or determined deceleration of the subject vehicle.

Therefore, the present invention provides an enhanced adaptive cruise control (ACC) system for a vehicle that is based on image data captured by a forward facing camera of the vehicle. The camera captures image data that provides information to the traffic situation classifier, which determines an appropriate gain set for the control based on the determined traffic situation (such as a vehicle ahead of the subject vehicle or a vehicle moving into the lane ahead of the subject vehicle or the speed limit or road condition of the road ahead of the subject vehicle or the like). Based on the determined traffic situation and selected gain set, the controller generates an output signal to either accelerate or decelerate the subject vehicle.

Optionally, the vision system may be operable to process image data to detect and/or determine other conditions at or near or around the vehicle, such as driving conditions or weather conditions or environmental conditions or the like. For example, the vision system may be operable to process image data to detect and warn the vehicle operator of a currently occurring earthquake. People driving automobiles can have difficulty identifying when an earthquake is currently underway, due to the vehicle's ability to mask earth movements to the vehicle occupants. This can lead to drivers entering areas with high risk, such as bridges, parking structures or into areas where objects can fall onto the vehicle, while an earthquake is occurring.

As cameras become integrated to automotive applications, processing of these video signals will enable the development of environmental warnings. Examples include warning for currently occurring earthquakes and high winds. Earthquake tremors produce seismic waves that can be detected by processing video images. Such earthquake movement is quite different than common vehicle movements, being in a predominantly horizontal direction. Processing of camera images can detect these movements, characterize them and provide a vehicle network message that can be used to generate a warning to the vehicle occupants.

For example, when the system detects that an earthquake is occurring, the system may generate a warning message to the occupant(s) of the vehicle (such as a message instructing the driver of the vehicle to pull over to a clear location and to stop and stay there until the shaking has stopped). In many vehicle applications, the camera is on when the vehicle is operating, even when the camera's primary function (such as, for example, reverse video image processing during a reversing maneuver), is not being used. The image data or video image data can be processed and the results of this processing can be shared on the vehicle's communication network to produce information that the driver and/or external data services can utilize. The system may characterize the movements in the image data captured by the camera and may combine such environmental information with other data available at or remote from the vehicle (such as with a navigation system, maps, cell phone services and the like).

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in PCT Application No. PCT/US2012/066570, filed Nov. 27, 2012 (Attorney Docket MAG04 FP-1960(PCT)), and/or PCT Application No. PCT/US2012/066571, filed Nov. 27, 2012 (Attorney Docket MAG04 FP-1961(PCT)), which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, an array of a plurality of photosensor elements arranged in at least 640 columns and 480 rows (preferably a megapixel imaging array or the like), with a respective lens focusing images onto respective portions of the array. The photosensor array may comprise a plurality of photosensor elements arranged in a photosensor array having rows and columns. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/103193; WO 2012/0116043; WO 2012/0145501; WO 2012/0145343; WO 2012/154919; WO 2013/019707; WO 2013/016409; WO 20102/145822; WO 2013/043661; WO 2013/048994′ WO2013/063014, and/or PCT Application No. PCT/US2012/062906, filed Nov. 1, 2012 (Attorney Docket MAG04 FP-1953(PCT)), and/or PCT Application No. PCT/US2012/063520, filed Nov. 5, 2012 (Attorney Docket MAG04 FP-1954(PCT)), and/or PCT Application No. PCT/US2012/064980, filed Nov. 14, 2012 (Attorney Docket MAG04 FP-1959(PCT)), and/or PCT Application No. PCT/US2012/066570, filed Nov. 27, 2012 (Attorney Docket MAG04 FP-1960(PCT)), and/or PCT Application No. PCT/US2012/066571, filed Nov. 27, 2012 (Attorney Docket MAG04 FP-1961(PCT)), and/or PCT Application No. PCT/US2012/068331, filed Dec. 7, 2012 (Attorney Docket MAG04 FP-1967(PCT)), and/or PCT Application No. PCT/US2012/071219, filed Dec. 21, 2012 (Attorney Docket MAG04 FP-1982 (PCT)), and/or PCT Application No. PCT/US2013/022119, filed Jan. 18, 2013 (Attorney Docket MAG04 FP-1997(PCT)), and/or PCT Application No. PCT/US2013/026101, filed Feb. 14, 2013 (Attorney Docket MAG04 FP-2010 (PCT)), and/or PCT Application No. PCT/US2013/027342, filed Feb. 22, 2013 (Attorney Docket MAG04 FP-2014(PCT)), and/or PCT Application No. PCT/US2013/036701, filed Apr. 16, 2013 (Attorney Docket MAG04 FP-2047 (PCT)) and/or U.S. patent applications, Ser. No. 13/894,870, filed May 15, 2013 (Attorney Docket MAG04 P-2062); Ser. No. 13/887,724, filed May 6, 2013 (Attorney Docket No. MAG04 P-2072); Ser. No. 13/851,378, filed Mar. 27, 2013 (Attorney Docket MAG04 P-2036); Ser. No. 61/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2030); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 61/825,752, filed May 21, 2013; Ser. No. 61/825,753, filed May 21, 2013; Ser. No. 61/823,648, filed May 15, 2013; Ser. No. 61/823,644, filed May 15, 2013; Ser. No. 61/821,922, filed May 10, 2013; Ser. No. 61/819,835, filed May 6, 2013; Ser. No. 61/819,033, filed May 3, 2013; Ser. No. 61/16,956, filed Apr. 29, 2013; Ser. No. 61/815,044, filed Apr. 23, 2013; Ser. No. 61/814,533, filed Apr. 22, 2013; Ser. No. 61/813,361, filed Apr. 18, 2013; Ser. No. 61/840,407, filed Apr. 10, 2013; Ser. No. 61/808,930, filed Apr. 5, 2013; Ser. No. 61/807,050, filed Apr. 1, 2013; Ser. No. 61/806,674, filed Mar. 29, 2013; Ser. No. 61/806,673, filed Mar. 29, 2013; Ser. No. 61/804,786, filed Mar. 25, 2013; Ser. No. 61/793,592, filed Mar. 15, 2013; Ser. No. 61/793,614, filed Mar. 15, 2013; Ser. No. 61/793,558, filed Mar. 15, 2013; Ser. No. 61/772,015, filed Mar. 4, 2013; Ser. No. 61/772,014, filed Mar. 4, 2013; Ser. No. 61/770,051, filed Feb. 27, 2013; Ser. No. 61/770,048, filed Feb. 27, 2013; Ser. No. 61/766,883, filed Feb. 20, 2013; Ser. No. 61/760,366, filed Feb. 4, 2013; Ser. No. 61/760,364, filed Feb. 4, 2013; Ser. No. 61/758,537, filed Jan. 30, 2013; Ser. No. 61/756,832, filed Jan. 25, 2013; Ser. No. 61/754,804, filed Jan. 21, 2013; Ser. No. 61/745,925, filed Dec. 26, 2012; Ser. No. 61/745,864, filed Dec. 26, 2012; Ser. No. 61/736,104, filed Dec. 12, 2012; Ser. No. 61/736,103, filed Dec. 12, 2012; Ser. No. 61/735,314, filed Dec. 10, 2012; Ser. No. 61/734,457, filed Dec. 7, 2012; Ser. No. 61/733,598, filed Dec. 5, 2012; Ser. No. 61/733,093, filed Dec. 4, 2012; Ser. No. 61/727,912, filed Nov. 19, 2012; Ser. No. 61/727,911, filed Nov. 19, 2012; Ser. No. 61/727,910, filed Nov. 19, 2012; Ser. No. 61/718,382, filed Oct. 25, 2012; Ser. No. 61/713,772, filed Oct. 15, 2012; Ser. No. 61/710,924, filed Oct. 8, 2012; Ser. No. 61/710,247, filed Oct. 2, 2012; Ser. No. 61/696,416, filed Sep. 4, 2012; Ser. No. 61/682,995, filed Aug. 14, 2012; Ser. No. 61/682,486, filed Aug. 13, 2012; Ser. No. 61/680,883, filed Aug. 8, 2012; Ser. No. 61/678,375, filed Aug. 1, 2012; Ser. No. 61/676,405, filed Jul. 27, 2012, which are all hereby incorporated herein by reference in their entireties. The system may communicate with other communication systems via any suitable means, such as by utilizing aspects of the systems described in International Publication No. WO 2013/043661, PCT Application No. PCT/US10/038477, filed Jun. 14, 2010, and/or PCT Application No. PCT/US2012/066571, filed Nov. 27, 2012 (Attorney Docket MAG04 FP-1961(PCT)), and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and 6,824,281, and/or International Publication Nos. WO 2010/099416 and/or WO 2011/028686, and/or U.S. patent application Ser. No. 12/508,840, filed Jul. 24, 2009, and published Jan. 28, 2010 as U.S. Pat. Publication No. US 2010-0020170, and/or PCT Application No. PCT/US2012/048110, filed Jul. 25, 2012 (Attorney Docket MAG04 FP-1907(PCT)), and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. patent applications, Ser. No. 12/091,359, filed Apr. 24, 2008 and published Oct. 1, 2009 as U.S. Publication No. US-2009-0244361; and/or Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,720,580; 7,038,577; 5,929,786 and/or 5,786,772, and/or U.S. pat. applications, Ser. No. 11/239,980, filed Sep. 30, 2005, now U.S. Pat. No. 7,881,496, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. patent applications, Ser. No. 11/226,628, filed Sep. 14, 2005 and published Mar. 23, 2006 as U.S. Publication No. US-2006-0061008, and/or Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described International Publication Nos. WO 2010/099416; WO 2011/028686; WO 2012/075250; WO 2013/019795; WO 2012-075250; WO 2012/154919; WO 2012/0116043; WO 2012/0145501; and/or WO 2012/0145313, and/or PCT Application No. PCT/CA2012/000378, filed Apr. 25, 2012 (Attorney Docket MAG04 FP-1819(PCT)), and/or PCT Application No. PCT/US2012/066571, filed Nov. 27, 2012 (Attorney Docket MAG04 FP-1961(PCT)), and/or PCT Application No. PCT/US2012/068331, filed Dec. 7, 2012 (Attorney Docket MAG04 FP-1967(PCT)), and/or PCT Application No. PCT/US2013/022119, filed Jan. 18, 2013 (Attorney Docket MAG04 FP-1997(PCT)), and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent applications, Ser. No. 12/091,525, filed Apr. 25, 2008, now U.S. Pat. No. 7,855,755; Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. An adaptive cruise control system for a vehicle, said adaptive cruise control system comprising:
a camera having a field of view forward of a vehicle equipped with said adaptive cruise control system, said camera operable to capture image data;
a traffic situation classifier, wherein said traffic situation classifier, responsive to captured image data, determines a traffic condition ahead of the equipped vehicle; and
a control, wherein said control is operable to process captured image data and, at least in part responsive to said traffic situation classifier, generate an output to accelerate or decelerate the equipped vehicle to establish a desired or appropriate velocity of the equipped vehicle based on the determined traffic condition and image data processing.

2. The adaptive cruise control system of claim 1, wherein said control is responsive to at least one of (i) a determined distance to a target vehicle ahead of the equipped vehicle and (ii) a determined relative velocity of a target vehicle ahead of the equipped vehicle, as determined from processing of captured image data.

3. The adaptive cruise control system of claim 1, wherein said traffic situation classifier is responsive to at least one of (i) information about a target vehicle that the equipped vehicle is following, (ii) information about at least one adjacent vehicle that the equipped vehicle is behind but in a different lane from the lane in which the equipped vehicle is traveling, and (iii) road Information pertaining to the road on which the subject vehicle is traveling.

4. The adaptive cruise control system of claim 3, wherein said traffic situation classifier is responsive to at least one of (i) information pertaining to a target vehicle flasher or turn signal, (ii) information pertaining to a target vehicle brake light, (iii) information pertaining to a target vehicle position in the lane in which the equipped vehicle is traveling, and (iv) information pertaining to a target vehicle lateral velocity.

5. The adaptive cruise control system of claim 3, wherein said traffic situation classifier is responsive to at least one of (i) information pertaining to an adjacent vehicle flasher or turn signal, (ii) information pertaining to an adjacent vehicle brake light, (iii) information pertaining to an adjacent vehicle position in the lane in which the equipped vehicle is traveling, and (iv) information pertaining to an adjacent vehicle lateral velocity.

6. The adaptive cruise control system of claim 3, wherein said traffic situation classifier is responsive to at least one of (i) road information pertaining to a road curvature ahead of the equipped vehicle, (ii) road information pertaining to a detection of a traffic sign indicative of a curve in the road ahead of the equipped vehicle, (iii) road information pertaining to a presence of an entry ramp, (iv) road information pertaining to a presence of an exit ramp, (v) road information pertaining to a speed limit, and (vi) road information pertaining to a presence of a construction area.

7. The adaptive cruise control system of claim 1, wherein said traffic situation classifier is operable, responsive at least in part to a determination of at least one of (i) an adjacent vehicle flasher and (ii) an adjacent vehicle lateral velocity, to determine an anticipated cut in traffic situation, and wherein said control, responsive at least in part to the determined anticipated cut in traffic situation, is operable to reduce the vehicle acceleration.

8. The adaptive cruise control system of claim 1, wherein said output of said control comprises one of a positive acceleration signal and a negative acceleration signal.

9. The adaptive cruise control system of claim 1, wherein said traffic situation classifier, responsive to captured image data, is operable to determine an appropriate gain set, and wherein said control is responsive to the determined gain set.

10. An adaptive cruise control system for a vehicle, said adaptive cruise control system comprising:
a camera having a field of view forward of a vehicle equipped with said adaptive cruise control system, said camera operable to capture image data;
a traffic situation classifier, wherein said traffic situation classifier, responsive to captured image data, determines a traffic condition ahead of the equipped vehicle;
wherein said traffic situation classifier is responsive to at least one of (i) information about a target vehicle that the equipped vehicle is following, (ii) information about at least one adjacent vehicle that the equipped vehicle is behind but in a different lane than the lane in which the equipped vehicle is traveling, and (iii) road Information pertaining to the road on which the subject vehicle is traveling;
a control, wherein said control is operable to process captured image data and, at least in part responsive to said traffic situation classifier, generate an output to accelerate or decelerate the equipped vehicle to establish a desired or appropriate velocity of the equipped vehicle based on the determined traffic condition and image data processing; and
wherein said output of said control comprises one of a positive acceleration signal and a negative acceleration signal.

11. The adaptive cruise control system of claim 10, wherein said control is responsive to at least one of (i) a determined distance to a target vehicle ahead of the equipped vehicle and (ii) a determined relative velocity of a target vehicle ahead of the equipped vehicle, as determined from processing of captured image data.

12. The adaptive cruise control system of claim 10, wherein said traffic situation classifier is responsive to at least one of (i) information pertaining to a target vehicle flasher or turn signal, (ii) information pertaining to a target vehicle brake light, (iii) information pertaining to a target vehicle position in the lane in which the equipped vehicle is traveling, and (iv) information pertaining to a target vehicle lateral velocity.

13. The adaptive cruise control system of claim 10, wherein said traffic situation classifier is responsive to at least one of (i) information pertaining to an adjacent vehicle flasher or turn signal, (ii) information pertaining to an adjacent vehicle brake light, (iii) information pertaining to an adjacent vehicle position in the lane in which the equipped vehicle is traveling, and (iv) information pertaining to an adjacent vehicle lateral velocity.

14. The adaptive cruise control system of claim 10, wherein said traffic situation classifier is responsive to at least one of (i) road information pertaining to a road curvature ahead of the equipped vehicle, (ii) road information pertaining to a detection of a traffic sign indicative of a curve in the road ahead of the equipped vehicle, (iii) road information pertaining to a presence of an entry ramp, (iv) road information pertaining to a presence of an exit ramp, (v) road information pertaining to a speed limit, and (vi) road information pertaining to a presence of a construction area.

15. The adaptive cruise control system of claim 10, wherein said traffic situation classifier is operable, responsive at least in part to a determination of at least one of (i) an adjacent vehicle flasher and (ii) an adjacent vehicle lateral velocity, to determine an anticipated cut in traffic situation, and wherein said control, responsive at least in part to the determined anticipated cut in traffic situation, is operable to reduce the vehicle acceleration.

16. The adaptive cruise control system of claim 10, wherein said traffic situation classifier, responsive to captured image data, is operable to determine an appropriate gain set, and wherein said control is responsive to the determined gain set.

17. An adaptive cruise control system for a vehicle, said adaptive cruise control system comprising:
a camera having a field of view forward of a vehicle equipped with said adaptive cruise control system, said camera operable to capture image data;
a traffic situation classifier, wherein said traffic situation classifier, responsive to captured image data, determines a traffic condition ahead of the equipped vehicle;
wherein said traffic situation classifier is responsive to at least one of (i) information about another vehicle that the equipped vehicle is following, (ii) information about at least one other vehicle that the equipped vehicle is behind but in a different lane than the lane in which the equipped vehicle is traveling, and (iii) road Information pertaining to the road on which the subject vehicle is traveling, (iv) information pertaining to a turn signal of another vehicle, (v) information pertaining to a brake light of another vehicle, (vi) information pertaining to another vehicle's position in the same lane in which the equipped vehicle is traveling, and (vii) information pertaining to a lateral velocity of another vehicle;
a control, wherein said control is operable to process captured image data and, at least in part responsive to said traffic situation classifier, generate an output to accelerate or decelerate the equipped vehicle to establish a desired or appropriate velocity of the equipped vehicle based on the determined traffic condition and image data processing; and
wherein said control is responsive to at least one of (i) a determined distance to another vehicle ahead of the equipped vehicle and (ii) a determined relative velocity of another vehicle ahead of the equipped vehicle, as determined from processing of captured image data.

18. The adaptive cruise control system of claim 17, wherein said output of said control comprises one of a positive acceleration signal and a negative acceleration signal.

19. The adaptive cruise control system of claim 17, wherein said traffic situation classifier is responsive to at least one of (i) road information pertaining to a road curvature ahead of the equipped vehicle, (ii) road information pertaining to a detection of a traffic sign indicative of a curve in the road ahead of the equipped vehicle, (iii) road information pertaining to a presence of an entry ramp, (iv) road information pertaining to a presence of an exit ramp, (v) road information pertaining to a speed limit, and (vi) road information pertaining to a presence of a construction area.

20. The adaptive cruise control system of claim 17, wherein said traffic situation classifier, responsive to captured image data, is operable to determine an appropriate gain set, and wherein said control is responsive to the determined gain set.
